(19) United States
(12) Patent Application Publication
(10) Pub. No.: US 2019/0347571 A1
(43) Pub. Date: Nov. 14, 2019

(54) CLASSIFIER TRAINING

(71) Applicant: KONINKLIJKE PHILIPS N.V., EINDHOVEN (NL)

(72) Inventors: Ashequl Qadir, Melrose, MA (US); Vivek Varma Datla, Ashland, MA (US); Kathy Mi Lee, Westford, MA (US); Sheikh Sadid Al Hasan, Cambridge, MA (US); Oladimeji Feyisetan Farri, Yorktown Heights, NY (US)

(21) Appl. No.: 16/478,556

(22) PCT Filed: Feb. 2, 2018
(86) PCT No.: PCT/EP2018/052719

§ 371 Date: Jul. 17, 2019

Related U.S. Application Data
(60) Provisional application No. 62/454,085, filed on Feb. 3, 2017.

(51) Int. Cl. G06N 20/00; G06F 17/27

(52) U.S. Cl. CPC G06N 20/00; G06F 17/27

(57) ABSTRACT

Methods and systems for training a classifier. The system includes two or more classifiers that can each analyze features extracted from inputted data. The system may determine a true label for the input data based on the first label and the second label, and retrain at least one of the first classifier and the second classifier based on a training example comprising the input data and the true label.

### CROSS REFERENCE TO RELATED APPLICATIONS

The present application claims priority to and the benefit of co-pending U.S. provisional application No. 62/454,085, filed on Feb. 3, 2017, the entire disclosure of which is hereby incorporated by reference as if set forth in its entirety herein.

### TECHNICAL FIELD

Embodiments described herein generally relate to systems and methods for training classifiers and, more particularly but not exclusively, to systems and methods for training classifiers using multiple models.

### BACKGROUND

Social media platforms offer a rich source of data for analyzing the emotions that people publicly share with others. These platforms allow people to publicly share personal experiences, news, or feelings, and are therefore a rich source of information that offers valuable insights into their preferences and their emotional well-being.

In addition to social media, many other forms of text and comments on news reports, articles, or headlines can also reflect and induce emotions. These comments and text can be analyzed to understand how newsworthy events affect peoples' emotional state and overall well-being.

While sentiment polarity analysis has been one of the mainstream interest areas for researchers, the ability to recognize finer dimensions of emotion (e.g., joy, anger, sadness) in social media entries or interactions has many practical applications. One application in particular that may benefit from a greater understanding of a person's emotions and well-being is the healthcare domain.

For example, this knowledge may help identify at-risk individuals who suffer from bipolar disorder or depression, individuals who are suicidal, or individuals with anger management issues. Additionally, this knowledge can help identify the events/news that can trigger these conditions for these at-risk individuals.

To recognize emotion, supervised classification procedures may classify textual content from social media messages, comments, blogs, news articles, or the like with respect to major emotions such as affection, anger, fear, joy, sadness, etc. Supervised classification algorithms generally require: (1) sufficient training data, which is costly to manually annotate; and (2) extensive feature engineering that characterizes/models the differences of the problem categories, which often requires domain experts.

Additionally, these supervised classification procedures traditionally do not have any built-in mechanism for error correction or means for self-improvement by learning from unlabeled data. These techniques also build a combined model in a single feature space, and therefore cannot take advantage of different independent views of a dataset.

Various deep learning models such as Convolutional Neural Networks (CNN) or Long-Short Term Memory networks (LSTM) have been successful in several text classification tasks in recent years. However, they also require large annotated data sets for training.

Semi-supervised algorithms (e.g., self-training, co-training algorithms) continually identify and add new training instances for retraining the models. However, they are often unable to generate novel or diverse training data (e.g., in self-training). Another drawback is that errors can propagate through iterations (e.g., in co-training).

A need exists, therefore, for systems and methods for training classifiers that overcome the disadvantages of existing techniques.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

According to one aspect, embodiments relate to a method of training a classifier. The method includes receiving labeled input data and unlabeled input data; extracting, from the labeled input data, a first set of features belonging to a first feature space; extracting, from the labeled input data, a second set of features belonging to a second feature space different from the first feature space; training a first classifier using the first feature set and applying the trained first classifier to the unlabeled input data to predict a first label; training a second classifier using the second feature set and applying the trained second classifier to the unlabeled input data to predict a second label; determining a true label for the unlabeled input data based on the first label and the second label; expanding the labeled input data with supplementary unlabeled data and its true label; and retraining at least one of the first classifier and the second classifier based on a training example comprising the expanded labeled input data and the true label.

In some embodiments, the method further includes extracting, from the labeled input data, a third set of features belonging to a third feature space different from the first feature space and the second feature space; and training a third classifier using the third feature set and applying the trained third classifier to the unlabeled input data to predict a third label. In some embodiments, determining the true label for the unlabeled input data based on the first label and the second label comprises identifying a consensus label among the first label, the second label, and the third label. In some embodiments, identifying the consensus label comprises weighting each of the first label, second label, and third label according to respective weights associated with the first, second, and third classifier to produce weighted votes for each unique label; and selecting the unique label having a highest weighted vote. In some embodiments, the method further includes generating weights for each of the first, second, and third classifier based on respective performances of the first, second, and third classifiers against an annotated dataset.

In some embodiments, the third set of features are selected from the group consisting of lexical features, semantic features, and distribution-based features.

In some embodiments, the first set of features and the second set of features are selected from the group consisting of lexical features, semantic features, and distribution-based features, wherein the first set of features are different from the second set of features.

According to another aspect, embodiments relate to a system for training a classifier. The system includes an interface for receiving labeled input data and unlabeled input data; at least one feature extraction module executing instructions stored on a memory to extract a first set of features belonging to a first feature space from the labeled input data, and extract a second set of features belonging to a second feature space from the labeled input data; a first classifier trained using the first feature set and configured to predict a first label associated with the unlabeled input data; a second classifier trained using the second feature set and configured to predict a second label associated with the unlabeled input data; and a prediction consensus generation module configured to determine a true label for the unlabeled input data based on the first label and the second label, and retrain at least one of the first classifier and the second classifier based on a training example comprising the expanded input data and the true label.

In some embodiments, the at least one feature extraction module is further configured to extract a third set of features belonging to a third feature space different from the first feature space and the second feature space, and the system further comprises a third classifier configured to output a third label associated with the third feature set. In some embodiments, the prediction consensus generation module determines the true label for the input data based on the first label and the second label by identifying a consensus label among the first label, the second label, and the third label. In some embodiments, the prediction consensus generation module is further configured to weight each of the first label, second label, and third label according to respective weights associated with the first, second, and third classifier to produce weighted votes for each unique label; and select the unique label having a highest weighted vote as the consensus label. In some embodiments, the prediction consensus generation module generates weights for each of the first, second, and third classifier based on respective performances of the first, second, and third classifiers against an annotated data set. In some embodiments, the third set of features are selected from the group consisting of lexical features, semantic features, and distribution-based features.

In some embodiments, the first set of features and the second set of features are selected from the group consisting of lexical features, semantic features, and distribution-based features, wherein the first set of features are different from the second set of features.

According to yet another aspect, embodiments relate to a computer readable medium containing computer-executable instructions for training a classifier. The medium includes computer-executable instructions for receiving input data; computer-executable instructions for extracting, from the input data, a first set of features belonging to a first feature space; computer-executable instructions for extracting, from the input data, a second set of features belonging to a second feature space different from the first feature space; computer-executable instructions for applying a first classifier to the first feature set to receive a first label; computer-executable instructions for applying a second classifier to the second feature set to receive a second label; computer-executable instructions for determining a true label for the input data based on the first label and the second label; and computer-executable instructions for retraining at least one of the first classifier and the second classifier based on a training example comprising the input data and the true label.

### BRIEF DESCRIPTION OF DRAWINGS

Non-limiting and non-exhaustive embodiments of the embodiments herein are described with reference to the following figures, wherein like reference numerals refer to like parts throughout the various views unless otherwise specified.

FIG. 1 illustrates a system for training a classifier in accordance with one embodiment;

FIG. 2 illustrates a workflow of the components of FIG. 1 in accordance with one embodiment;

FIG. 3 illustrates a workflow of the first classifier of FIG. 1 in accordance with one embodiment;

FIG. 4 illustrates a workflow of the second classifier of FIG. 1 in accordance with one embodiment;

FIG. 5 illustrates a workflow of the third classifier of FIG. 1 in accordance with one embodiment;

FIG. 6 illustrates a workflow of the prediction threshold tuning module of FIG. 1 in accordance with one embodiment;

FIG. 7 illustrates a workflow of the prediction consensus generation module of FIG. 1 in accordance with one embodiment; and

FIG. 8 depicts a flowchart of a method for training a classifier in accordance with one embodiment;

FIG. 9 illustrates a system for training a classifier in accordance with another embodiment; and

FIG. 10 depicts a flowchart of a method for training a classifier using the system of FIG. 9 in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Embodiments described herein provide an iterative framework that may combine classifiers with different views of a feature space. In some embodiments, such as those for classifying emotions based on social media content, these classifiers may include (1) a lexical feature-based classifier; (2) a semantic feature-based classifier; and (3) a distributional feature-based classifier. These classifiers may then vote on a classification label, which may then be used to further train the classifiers in future iterations.

This ensemble-based framework offers two major benefits. First, these embodiments offer an error correction opportunity for any of the classifiers because of the consensus with another classifier. For example, if a first classifier incorrectly predicts the emotion e for a tweet, but the second and/or third classifiers do not, not incorporating the tweet into training data for the next iteration therefore avoids a potential mistake that could propagate through successive iterations. This is in contrast to existing co-training techniques, in which the tweet would still be provided as a training instance for the second and third classifiers.

A second advantage is that a classifier can acquire new training instances that the classifier may not have been able to identify by itself. For example, if a first classifier fails to predict an emotion e for a tweet, and the second and third classifiers predict e for a tweet, the tweet is still provided as a training instance for the first classifier for the next iteration. This is in contrast to traditional self-training techniques where, if a classifier does not identify an emotion e for a tweet, the tweet is not added to the training set for the next iteration.

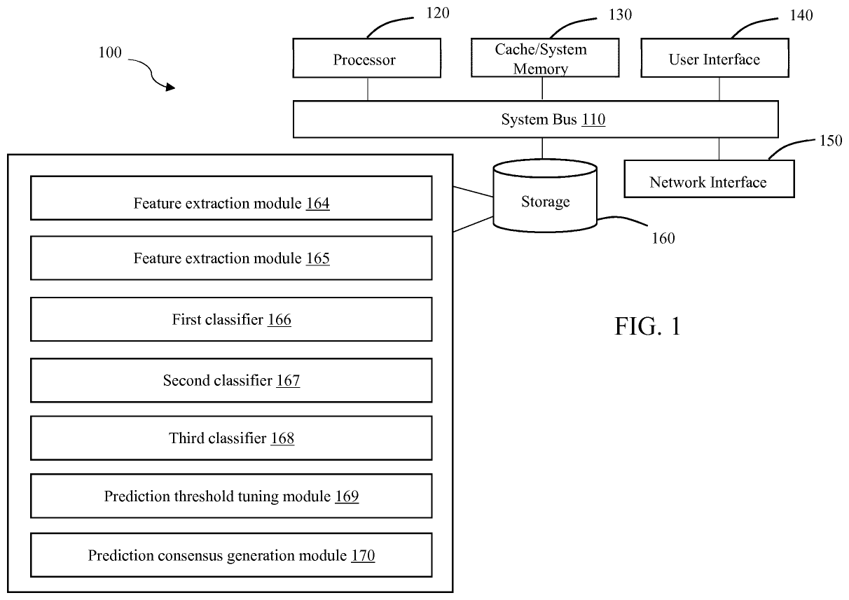

FIG. 1 illustrates a system 100 for training a classifier in accordance with one embodiment. The system 100 may include a processor 120, memory 130, a user interface 140, a network interface 150, and storage 160 interconnected via one or more system buses 110. It will be understood that FIG. 1 constitutes, in some respects, an abstraction and that the actual organization of the system 100 and the components thereof may differ from what is illustrated.

The processor 120 may be any hardware device capable of executing instructions stored on memory 130 and/or in storage 160, or otherwise any hardware device capable of processing data. As such, the processor 120 may include a microprocessor, field programmable gate array (FPGA), application-specific integrated circuit (ASIC), or other similar devices.

The memory 130 may include various non-transient memories such as, for example L1, L2, or L3 cache or system memory. As such, the memory 130 may include static random access memory (SRAM), dynamic RAM (DRAM), flash memory, read only memory (ROM), or other similar memory devices and configurations. The exact configuration of the memory 130 may vary as long as instructions for training the classifier(s) can be executed.

The user interface 140 may include one or more devices for enabling communication with a user. For example, the user interface 140 may include a display, a mouse, and a keyboard for receiving user commands. In some embodiments, the user interface 140 may include a command line interface or graphical user interface that may be presented to a remote terminal via the network interface 150. The user interface 140 may execute on a user device such as a PC, laptop, tablet, mobile device, or the like.

The network interface 150 may include one or more devices for enabling communication with other remote devices. For example, the network interface 150 may include a network interface card (NIC) configured to communicate according to the Ethernet protocol. Additionally, the network interface 150 may implement a TCP/IP stack for communication according to the TCP/IP protocols. Various alternative or additional hardware or configurations for the network interface 150 will be apparent. The network interface 150 may connect with or otherwise receive data from a variety of sources such as social media platforms.

The storage 160 may include one or more machine-readable storage media such as read-only memory (ROM), random-access memory (RAM), magnetic disk storage media, optical storage media, flash-memory devices, or similar storage media. In various embodiments, the storage 160 may store instructions or modules for execution by the processor 120 or data upon which the processor 120 may operate.

For example, the storage 160 may include one or more feature extraction modules 164 and 165, a first classifier 166, a second classifier 167, a third classifier 168, a prediction threshold tuning module 169, and a prediction consensus generation module 170. The exact components included as part of the storage 160 may vary and may include others in addition to or in lieu of those shown in FIG. 1. Additionally or alternatively, a single component may perform the functions of more than one component illustrated in FIG. 1.

The feature extraction modules 164 and 165 may extract certain features from the datasets for analysis by the classifiers. Although there are two feature extraction modules illustrated in FIG. 1, the number of feature extraction modules may vary. For example, there may be one feature extraction module associated with each classifier. Or, a single feature extraction module may be configured to extract certain features for each classifier. Feature extraction module 164 will be described as performing the feature extraction functions in the remainder of the application.

In embodiments for classifying emotions, the first classifier 166 may be a lexical feature-based classifier. The first classifier may 166 may, for example, use a bag-of-words modeling procedure on a received dataset.

The second classifier 167 may consider semantic-based features of a social media entry. To model the semantic feature space, the second classifier 167 may use semantic relations from a knowledge base that represents expert knowledge in the semantic space, as well as semantic relations created to exploit distributional similarity metrics that represent semantic relations.

The second classifier 167 may use a binary feature for any word/term that appears in a suitable knowledge base (e.g., WORDNET), along with a hypernym, hyponym, meronym, verb-group, or a “similar-to” relation with a word in a social media entry. Each of these relations may represent a unique feature type.

For example, “car” has a hypernym relation with “motor vehicle” and a meronym relation with “window.” If “car” appears as a word in a social media entry, then a binary feature may represent the relation-term pair “hypernym: motor vehicle”, and another binary feature may represent the relation-term pair “meronym: window.” Word senses used in a social media entry are not disambiguated, but instead all senses may be used as part of the semantic feature dictionary.

Additionally, semantically similar words (determined through distributional similarity measures as additional semantic features) may be used. A word embeddings model trained on a large data set may be used to, for each word in a social media entry, retrieve the twenty (20) most similar words using cosine similarity to the embedding vectors. Then, a binary feature for each semantically similar word to the words in a social media entry may be retrieved.

The third classifier 168 may be a distributional feature-based classifier. The third classifier 168 may, for example, use existing emotion and sentiment lexicons, and consider the distributional similarity of words in a tweet with seed emotion tokens.

To generate the first set of distribution features, the third classifier 168 may use the lexicon of emotion indicators known in the art. The lexicon may contain emotion hashtags, hashtag patterns, and emotion phrases created from the hashtags and the patterns. The indicators may belong to one of five emotion categories: (1) affection; (2) anger/rage; (3) fear/anxiety; (4) joy; and (5) sadness/disappointment. For each indicator of the emotions, the third classifier 168 may create one binary feature. For a given tweet or social media entry, a feature value is set to “1” if the tweet contains a phrase or a hashtag from one of the corresponding emotions' lexicon.

In some embodiments, a set of two word-emotion lexicons may be used that considers lexicons created using crowdsourcing and one created using automatic methods. The lexicons may contain word associations (e.g., binary or real value scores) with respect to a variety of emotions (e.g., anger, fear, anticipation, trust, surprise, sadness, joy, and disgust) and two sentiments (either negative or positive). For a given social media entry, a feature value may be set to 1 if the entry contains a word from one of the lexicons associated with one of the above eight emotions.

In some embodiments, another set of distribution features may use the AFINN sentiment lexicon, which contains 2477 words with a positive or negative sentiment score. With the lexicon, the third classifier 168 may use two binary features, one for positive and one for negative. For a given social media entry, a feature value is set to 1 if the entry contains a word that has a positive or negative value in the AFINN lexicon.

In some embodiments, the third classifier 168 may determine the distributional similarity of the words in social media entries with seed emotion tokens. To model the distributional similarity for an entry with the emotion categories, the third classifier 168 may use seed tokens of the emotion categories and determine their cosine similarity with the words of an entry in the distributional space.

S may be an ordered set of seed emotion tokens and T may be the set of words in a tweet. The third classifier 168 may create a vector as the distributional representation of a tweet with respect to the previously mentioned emotion categories by the following:

Dist(seedₛ,tweet)=argmaxCosine(seedₛ,x),x∈T

In this case, sins are the seed tokens of the annotation categories, and the Dist(seedₛ, tweet) function represents the 5^{th} element of the vector.

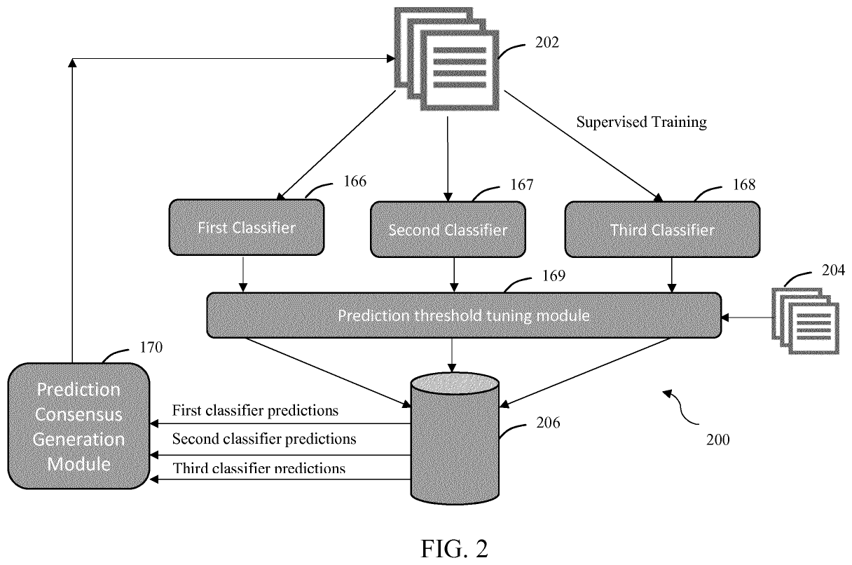

FIG. 2 illustrates a workflow 200 of the components of FIG. 1 in accordance with one embodiment. In this embodiment, annotated (i.e., labeled) training data 202 may comprise tweets, blogs, news articles, headlines, or the like. Again, this embodiment is being described in the context of classifying emotions based on social media content. However, this architecture may be extended to train classifiers in other types of applications or domains as well.

Classifiers 166, 167, and 168 may receive the annotated training data 202 for supervised training. As mentioned previously, the first classifier 166 may be a lexical feature-based classifier, the second classifier 167 may be a semantic feature-based classifier, and the third classifier 168 may be a distributional feature-based classifier. After supervised training on the annotated training data 202, the classifiers 166, 167, and 168 may each provide a trained classification model.

The trained classification models of the classifiers 166, 167, and 168 may be executed on expert-annotated training data 204 for further improvement by the prediction threshold tuning module 169. The prediction threshold tuning module 169 may apply each classifier model to the held-out, expert-annotated tuning data 204 to determine high confidence prediction thresholds.

The trained classification models of the classifiers 166, 167, and 168 may then analyze unlabeled data 206 for classification. This unlabeled data 206 may include a large collection of social media entries, tweets, blogs, news articles, headlines, or the like. Each classifier 166, 167, and 168 may output a label indicating whether they believe a social media entry is associated with an emotion e.

The prediction consensus generation module 170 may take a weighted vote or a majority vote of the classification decisions from the classifiers 166, 167, and 168 and output a prediction regarding the unlabeled data 206. The output of the prediction consensus generation module 170 may be incorporated in the training data 202 and the process repeated. Accordingly, the size of the annotated dataset 202 increases with each iteration and the size of the unlabeled dataset 206 decreases with each iteration. This process may be repeated until a stopping criteria is met.

The architecture 200 of FIG. 2 can be adapted to add more classifiers as component parts of the ensemble that use different classification procedures. For example, Support Vector Machine (SVM), Logistic Regression (LR), etc., with feature engineering, or neural network classification models such as Convolutional Neural Networks (CNN) without feature designing or the like may be used to accomplish the features of various embodiments described herein.

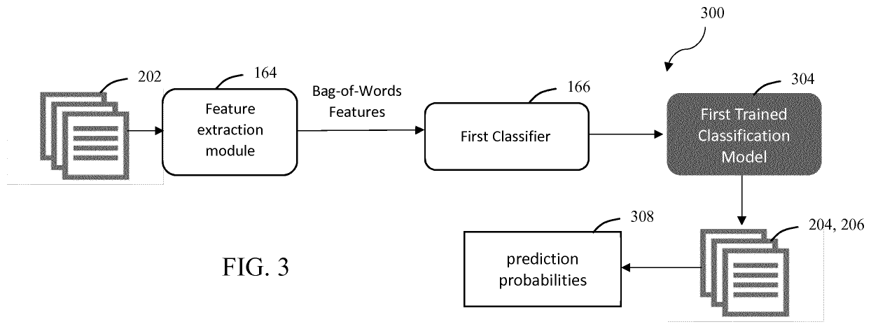

FIG. 3 illustrates a workflow 300 of the first classifier 166 in accordance with one embodiment. As stated previously, the first classifier 166 may consider a lexical view of the dataset 202. The dataset 202 may be supplied to the feature extraction module 164, and may be an annotated training dataset comprising social media entries including tweets, blogs, comments, news articles, headlines, or the like, as well as data regarding a user's reactions to such data. The feature extraction module 164 may then extract bag-of-words features from the dataset 202, which may be communicated to the first classifier 166 for supervised learning.

As a result of the supervised learning procedure using the bag-of-words features, the first classifier 166 may execute a first trained classification model 304. The model 304 may consider certain weights assigned to certain features based on, for example, logistic regression analysis. These weights essentially tell the system the importance of a particular feature. The trained classification model 304 of the first classifier 166 may then execute on the expert, annotated data 204 as part of a tuning procedure as well as unlabeled data 206 to output prediction probabilities 308.

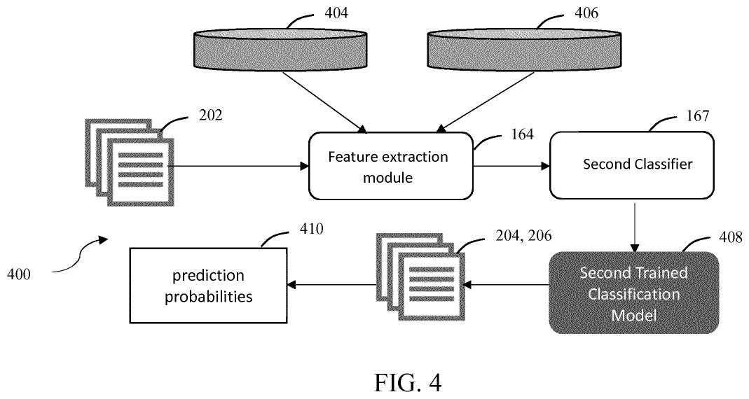

FIG. 4 illustrates a workflow 400 of the second classifier 167 in accordance with one embodiment. As stated previously, the second classifier 167 may consider a semantic view of the dataset 202 (which may be the same dataset 202 of FIG. 3).

A feature extraction module 164 may receive semantically similar words determined from a distributional vector space from one or more databases 404 of pre-trained word embeddings. The second classifier 167 may also receive data regarding the semantic relations of words in the dataset 202 (e.g., hypernyms, meronyms, holonyms, hyponyms, verb-groups, similar words, synonyms, antonyms, etc.). This type of data regarding semantic relations may be retrieved from one or more semantic knowledge databases 406 (such as WordNet).

The extracted semantic features may be communicated to the second classifier 167 for supervised learning. As a result of the supervised learning procedure, the second classifier 167 may execute a second trained classification model 408. The trained classification model 408 may consider certain weights assigned to certain features based on, for example, logistic regression analysis. These weights essentially tell the system the importance of a particular feature. The trained classification model 408 of the second classifier 167 may then execute on the expert, annotated data 204 as part of the tuning procedure as well as unlabeled data 206 to output prediction probabilities 410.

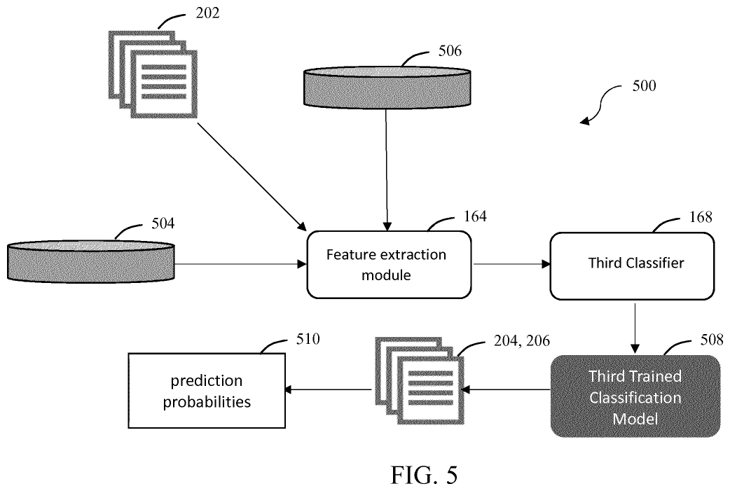

FIG. 5 illustrates a workflow 500 of the third classifier 168 in accordance with one embodiment. As stated previously, the third classifier 168 may consider distributional features of the dataset 202 (which may be the same as the data set 202 of FIGS. 3 and 4).

The feature extraction module 164 may extract distributional features from the dataset 202. The feature extraction module 164 may receive seed emotion words from one or more seed word databases 504. The feature extraction module 164 may also receive words similar to the emotion seed words from one or more previously-trained word embeddings databases 506.

The feature extraction module 164 may extract distributional features related to the vector differences between seed emotion word(s) and the most similar words in text of the dataset 202. The extracted features may be communicated to the third classifier 168 for supervised learning.

As a result of the supervised learning procedure, the third classifier 168 may therefore execute a third trained classification model 508. The trained classification model 508 may consider certain weights assigned to certain features based on, for example, logistic regression analysis. These weights essentially tell the system the importance of a particular feature. The trained classification model 508 may then execute on the expert, annotated data 204 as part of the tuning procedure as well as unlabeled data 206 to output prediction probabilities 510.

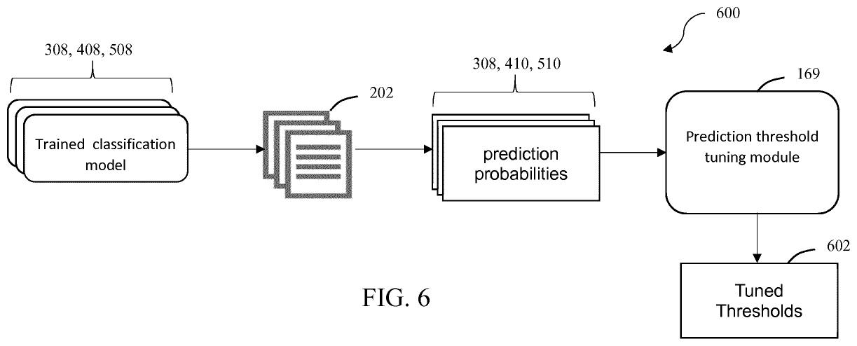

FIG. 6 depicts a workflow 600 of the prediction threshold tuning module 169 in accordance with one embodiment. The prediction threshold tuning module 169 may receive the prediction probabilities 308, 410, 510 associated with the input data 202 from the classification models 304, 408, and 508, respectively.

The prediction threshold tuning module 169 may filter out or otherwise select certain predictions based on their confidence scores. For example, the prediction threshold tuning module 169 may select those predictions with the top 25% highest confidence values. The output of the prediction threshold tuning module 169 may be a set of tuned, prediction thresholds 602 to ensure high precision (e.g., per emotion, per classifier).

In the context of the present application, a “threshold” may be defined as the cut-off probability, above which an instance is classified into an emotion category. If a predicted probability is below the threshold, the instance is not classified under the emotion.

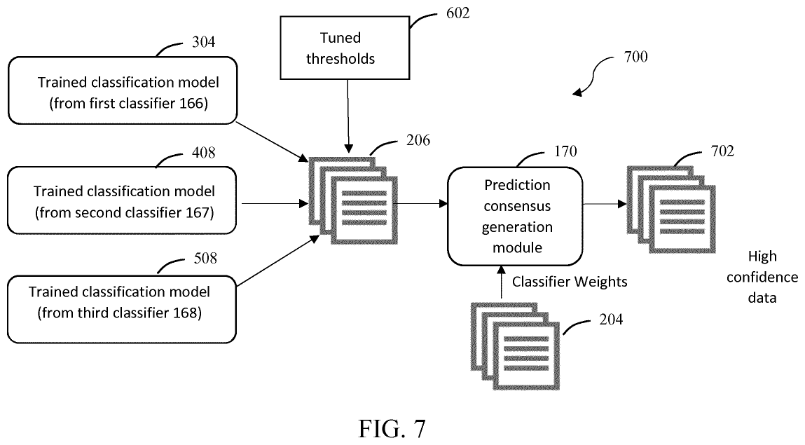

FIG. 7 illustrates a workflow 700 of the prediction consensus generation module 170 in accordance with one embodiment. The trained models 304, 408, and 508, of the classifiers 166, 167, 168, respectively, may analyze the unlabeled data 206. The unlabeled data 206 may include tweets, blogs, news articles, headlines, or the like.

The trained models 304, 408, and 508 may also consider the tuned thresholds 702 supplied by the prediction threshold tuning module 169. The models 304, 408, and 508 may then supply classification predictions which are communicated to the prediction consensus generation module 170 to conduct a weighted voting procedure.

The weights for each classifier 166, 167, and 168 may be determined from the annotated validation data 204. The output of the prediction consensus generation module 169 may therefore be high confidence annotated data 702. This high confidence annotated data 702 may then be added to the annotated training data 202 for further training the classifiers. Accordingly, the size annotated training dataset 202 may continually increase with each iteration.

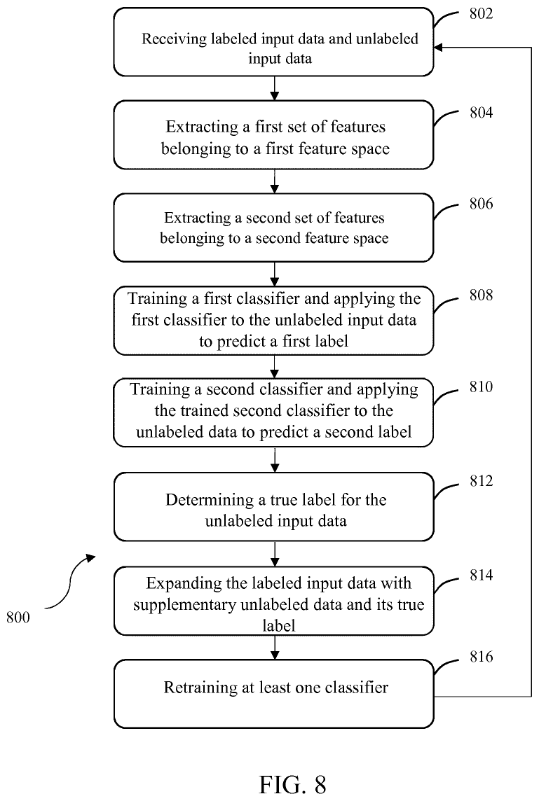

FIG. 8 depicts a flowchart of a method 800 for training a classifier in accordance with one embodiment. Step 802 involves receiving labeled input data and unlabeled data. This data may include annotated social media data, such as tweets or online comments made by a user.

Step 804 involves extracting, from the labeled input data, a first set of features belonging to a first feature space. Step 804 may be performed by a feature extraction module such as the feature extraction module 164 of FIG. 1, for example. This first set of features may include semantic features, lexicon features, or distributional features.

Step 806 involves extracting, from the labeled input data, a second set of features belonging to a second feature space different from the first feature space. This step may be performed by a feature extraction module such as the feature extraction module 164 of FIG. 1, for example. These features may include semantic features, lexicon features, or distributional features. Regardless of the features extracted, the second set of features should be different from the first set of features.

Although not shown in FIG. 8, some embodiments may further extract a third set of features belonging to a third feature space that is different from the first feature space and the second feature space. This step may be performed by a feature extraction module such as the feature extraction module 164 of FIG. 1, for example. This third set of features may include semantic features, lexicon features, or distributional features. Regardless of the features extracted, the third set of features should be different from the first set of features and the second set of features.

Step 808 involves training a first classifier using the first feature set and applying the trained first classifier to the unlabeled input data to predict a first label. The first classifier may be similar to the first classifier 164 of FIG. 1, for example, and may be a lexical feature-based classifier. The first label may indicate whether or not the input data is associated with a particular emotion, such as joy or anger, based on the analysis by the first classifier.

Step 810 involves training a second classifier using the second feature set and applying the trained second classifier to the unlabeled input data to predict a second label. The second classifier may be similar to the second classifier 167 of FIG. 1, for example, and may be a semantic feature-based classifier. The second label may indicate whether or not the input data is associated with a particular emotion based on the analysis by the second classifier.

Although not illustrated in FIG. 8, some embodiments may further include a step of training a third classifier using an extracted third feature set to predict a third label. This third classifier may be similar to the third classifier 168 of FIG. 1, for example, and may be a distribution feature-based classifier. The third label may indicate whether or not the input data is associated with a particular emotion based on the analysis by the third classifier.

Step 812 involves determining a true label for the unlabeled input data based on at least the first label and the second label. This true label may be the result of a vote from each of the classifiers as to whether the data exhibits a particular emotion on which the classifiers are trained.

In some embodiments, determining the true label for the input data based on the first label and the second label comprises identifying a consensus label among the first label, the second label, and the third label. In some embodiments, identifying the consensus label may involve weighting each of the first label, second label, and third label according to respective weights associated with the first, second, and third classifier to produce weighted votes for each unique label. These weights may be based on the respective performances of the classifiers against the labeled input data. Then, the unique label having the highest weighted vote may be selected as the consensus label.

Step 814 involves expanding the labeled input data with supplementary unlabeled data and its true label. As this data is now labeled, it may be added to the set of training data and used for future iterations.

Step 816 involves retraining at least one of the first classifier and the second classifier based on a training example comprising the expanded labeled input data and the true label. The inputted data, which is now associated with a true label, may be then added back to an annotated training set of data. The method 800 may then be iterated (i.e., adding to the annotated training set, and retraining) multiple times until no new training examples can be added to the annotated set.

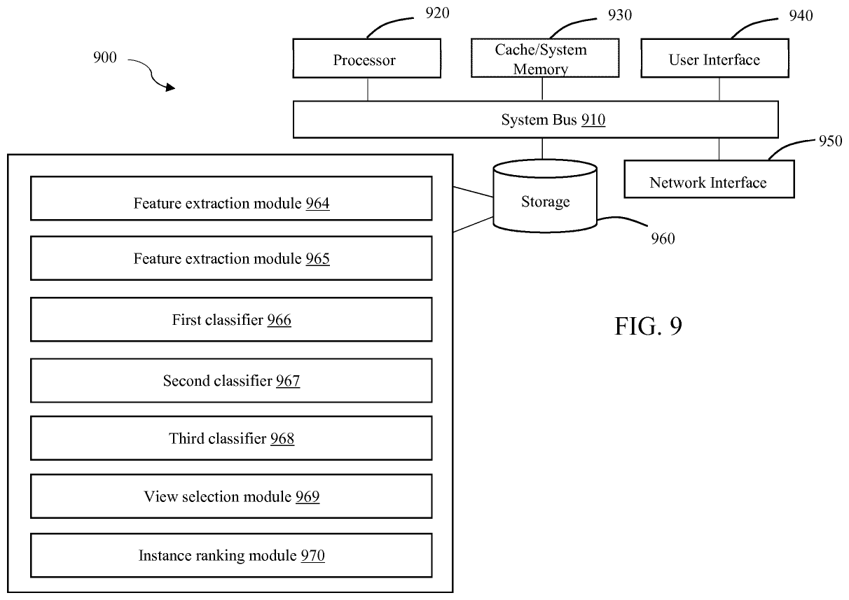

FIG. 9 illustrates a system 900 for training a classifier in accordance with another embodiment. In this embodiment, classifiers are independently trained with each of three views of a feature space (as in FIG. 1) to predict an emotion.

In classic co-training, the most confidently labeled instances from unlabeled data identified by each classifier are given as supplementary training instances to the other classifiers. However, it is possible that not all of the classifiers may be adequately suited to identify the right set of instances as supplementary data for the other classifiers.

The system of FIG. 9, however, may identify the weakest of the three classifiers as a target-view classifier to be improved. To achieve this, the remaining feature space view(s) may train a complementary-view classifier based on the assumption that this complementary-view classifier will perform better than the weak classifier. The complementary-view classifier may then guide the target-view classifier towards improving itself with new training data that is likely misclassified by the target-view classifier.

Components 910, 920, 930, 940, and 950 are similar to components 110, 120, 130, 140, and 150, respectively, of FIG. 1 and are not repeated here. The extraction modules 964, 965, and classifiers 966-968 are similar to the components 164, 165, and 166-168, respectively, of FIG. 1 and are not repeated here.

The system 900 of FIG. 9 may further include a view selection module 969. The view selection module 969 may be configured to evaluate individual-view classifiers' performance on a validation dataset and designate the weakest performing classifier as a target-view classifier. The view selection module 969 may also combine the remaining views (from the other classifier(s)) to create a complementary-view classifier.

The system 900 of FIG. 9 may also include an instance ranking module 970. The instance ranking module 970 may be configured to evaluate and combine the prediction probabilities of the target-view and complementary-view classifiers to select supplemental training data for retraining the classifiers.

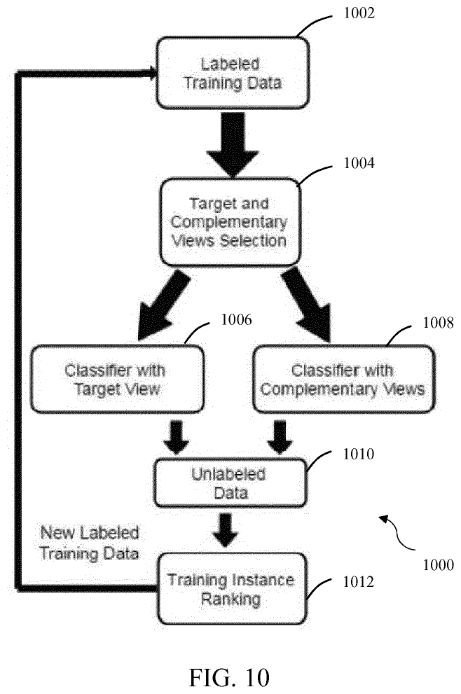

FIG. 10 depicts an iterative framework 1000 for training the multiple classifiers of FIG. 9 in accordance with another embodiment. In this particular embodiment, the framework 1000 may be used to classify emotions of users based on social media content.

First, in event 1002, a previously-annotated data set (e.g., a dataset of social media entries such as tweets, comments, posts, etc.) associated with emotion categories E (e.g., affection, joy, anger) are received using an interface for training an initial set of binary classifiers for each emotion e∈E.

Each classifier 966, 967, and 968 may be trained for an emotion e. As mentioned previously, the first classifier 966 may have a lexical view (LEX_{c}), the second classifier 967 may have a semantic view (SEM_{c}), and the third classifier 968 may have a distributional view (EMP_{c}) of the feature space.

In event 1004, for an emotion e, the classifiers 966, 967, and 968 may be independently applied to the previously-annotated validation data set to evaluate their performance. The weakest of the classifiers is selected as the target classifier with the target-view by the view selection module 969 in event 1006. This target classifier is the classifier selected for improvement.

In event 1008, the other classifier(s) are selected by the view selection module 969 as the complementary-view classifier and used to generate at least one complementary view to the target view. Only one of the other, “non-target” views may be used, or both of the other non-target views may be used and combined to provide at least one complementary view. Both the target and the complementary classifiers are applied to an unlabeled data set in event 1010, and the target-view classifier and the complementary view-classifier may each assign a classification probability to each social media entry (e.g., a tweet).

Pₜ(tweet) may be the probability assigned by the target classifier, and P_{c}(tweet) may be the probability assigned by the complementary classifier. To rank the unlabeled data using these two probabilities, the instance ranking module 970 may assign a score for a particular tweet by executing the following function:

score(tweet)=P_{c}(tweet)×(1−Pₜ(tweet))

The above function more strongly rewards tweets where the complementary classifier assigns a high probability but the target classifier does not. This reflects an improvement opportunity for the target classifier.

The instance ranking module 970 may sort all of the unlabeled data using the scores generated by the above scoring function. The prediction consensus generation module may then select, for example, the top 25% of the original training data size (so that the new data does not overwhelm the previous training data). After expanding the original training dataset the classifiers may be re-trained and the process repeated.

The classifiers with the complementary views could already identify validation data set instances better than the target view. It is therefore expected that, by combining their feature space, the new classifier will be able to identify new instances better than the target-view classifier.

In event 1010, at least two classifier outputs are generated for each unlabeled social media entry (e.g., a tweet) one from the target classifier and one from the complementary classifier(s). Using their assigned classification probabilities to the social media entries, the instance ranking module 970 may execute a ranking function to identify the instances of which the target classifier is less confident.

The highly ranked social media entries may then be added to the training data of the target classifier for a particular emotion e. The process illustrated in FIG. 9 may then be iterated until, for example, a stopping criteria is met.

The system 900 and method 1000 of FIGS. 9 and 10, respectively, offer two important benefits. First, they offer an error correction opportunity by using a better performing classifier. Second, they present an opportunity for the target-view classifier to acquire new training instances that the target-view classifier was unable to identify by itself using its own feature space.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

1. A method of training a classifier, the method comprising:
receiving labeled input data and unlabeled input data;
extracting, from the labeled input data, a first set of features belonging to a first feature space;
extracting, from the labeled input data, a second set of features belonging to a second feature space different from the first feature space;
extracting, from the labeled input data, a third set of features belonging to a third feature space different from the first feature space and the second feature space;
training a first classifier using the first feature set and applying the trained first classifier to the unlabeled input data to predict a first label;
training a second classifier using the second feature set and applying the trained second classifier to the unlabeled input data to predict a second label;
training a third classifier using the third feature set and applying the trained third classifier to the unlabeled input data to predict a third label;
identifying a consensus label for the unlabeled input data based on the first label, the second label, and the third label;
expanding the labeled input data with supplementary unlabeled data and its true consensus label; and
retraining at least one of the first classifier and the second classifier based on a training example comprising the expanded labeled input data and the consensus label.

2. (canceled)

3. (canceled)

4. The method of claim 1 wherein identifying the consensus label comprises:
weighting each of the first label, second label, and third label according to respective weights associated with the first, second, and third classifier to produce weighted votes for each unique label; and
selecting the unique label having a highest weighted vote.

5. The method of claim 4, further comprising generating weights for each of the first, second, and third classifier based on respective performances of the first, second, and third classifiers against an annotated dataset.

6. The method of claim 1 wherein the third set of features are selected from the group consisting of lexical features, semantic features, and distribution-based features.

7. The method of claim 1 wherein the first set of features and the second set of features are selected from the group consisting of lexical features, semantic features, and distribution-based features, wherein the first set of features are different from the second set of features.

8. A system for training a classifier, the system comprising:
an interface for receiving labeled input data and unlabeled input data;
at least one feature extraction module executing instructions stored on a memory to:
extract a first set of features belonging to a first feature space from the labeled input data, and
extract a second set of features belonging to a second feature space from the labeled input data;
extract, from the labeled input data, a third set of features belonging to a third feature space different from the first feature space and the second feature space;
a first classifier trained using the first feature set and configured to predict a first label associated with the unlabeled input data;
a second classifier trained using the second feature set and configured to predict a second label associated with the unlabeled input data;
a third classifier trained using the third feature set and configured to predict a third label associated with the unlabeled input data; and
a prediction consensus generation module configured to:
identify a consensus label for the unlabeled input data based on the first label, the second label, and the third label,
expand the labeled input data with supplementary unlabeled data and its consensus label, and
retrain at least one of the first classifier and the second classifier based on a training example comprising the expanded input data and the consensus label.

9. (canceled)

10. (canceled)

11. The system of claim 8 wherein the prediction consensus generation module is further configured to:
weight each of the first label, second label, and third label according to respective weights associated with the first, second, and third classifier to produce weighted votes for each unique label; and
select the unique label having a highest weighted vote as the consensus label.

12. The system of claim 11 wherein the prediction consensus generation module generates weights for each of the first, second, and third classifier based on respective performances of the first, second, and third classifiers against an annotated dataset.

13. The system of claim 8 wherein the third set of features are selected from the group consisting of lexical features, semantic features, and distribution-based features.

14. The system of claim 8 wherein the first set of features and the second set of features are selected from the group consisting of lexical features, semantic features, and distribution-based features, wherein the first set of features are different from the second set of features.

15. A computer readable medium containing computer-executable instructions for training a classifier, the medium comprising:
computer-executable instructions for receiving labeled input data and unlabeled input data;
computer-executable instructions for extracting, from the labeled input data, a first set of features belonging to a first feature space;
computer-executable instructions for extracting, from the labeled input data, a second set of features belonging to a second feature space different from the first feature space;
computer-executable instructions for extracting, from the labeled input data, a third set of features belonging to a third feature space different from the first feature space and the second feature space;
computer-executable instructions for training a first classifier using the first feature set and applying the trained first classifier to the unlabeled input data to predict a first label;
computer-executable instructions for training the second classifier using the second feature set and applying the trained second classifier to the unlabeled input data to predict a second label;
computer-executable instructions for training a third classifier using the third feature set and applying the trained third classifier to the unlabeled input data to predict a third label;
computer-executable instructions for identifying a consensus label for the unlabeled input data based on the first label, the second label, and the third label;
computer-executable instructions for expanding the labeled input data with supplementary unlabeled data and its consensus label; and
computer-executable instructions for retraining at least one of the first classifier and the second classifier based on a training example comprising the expanded labeled input data and the consensus label.
